(19) United States
(12) Patent Application Publication
(10) Pub. No.: US 2010/0014308 A1
(43) Pub. Date: Jan. 21, 2010

(54) LIGHTING APPARATUS AND METHOD OF MANUFACTURE

(75) Inventors: Gary Robin, Niles, IL (US); Michael Heidegger, Orland Park, IL (US); Paul Katz, Chicago, IL (US)

Correspondence Address: FITCH EVEN TABIN & FLANNERY, 120 SOUTH LASALLE STREET, SUITE 1600, CHICAGO, IL, 60603-3406, US

(73) Assignee: TRIPLEX MANUFACTURING COMPANY, Chicago, IL (US)

(21) Appl. No.: 12/173,071

(22) Filed: Jul. 15, 2008

(51) Int. Cl. B60Q 1/00; H01J 9/02

(52) U.S. Cl. 362/545; 445/23

(57) ABSTRACT

A lighting subassembly includes at least one light emitting device, a solid, light transmitting material, and a mating arrangement. The solid, light-transmitting material at least partially surrounds the at least one light emitting device. The mating arrangement communicates with the solid, light transmitting material and is configured to be attachable to a corresponding base assembly. In some examples, the lighting subassembly further includes a frame and the frame is integral with the solid, light-transmitting material.

### FIELD OF THE INVENTION

The field of the invention relates to lighting devices and methods of manufacturing these devices.

### BACKGROUND

Different types of lighting devices are used today. These devices are deployed in a wide range of settings and include indoor lamps, outdoor lamps, and lighting devices used on or in vehicles to name a few examples.

Some of these previous vehicular lighting systems have used light emitting diodes (LEDs) or similar lighting elements. For instance, vehicles frequently use LEDs in lighting devices such as tail lamps, stopping lamps, or turning lamps. In these lighting systems, a printed circuit board is typically used to hold the LEDs. To protect the LEDs from exposure to moisture or other elements, a very thin coating of protective material typically less than approximately 1 mm in thickness is sometimes applied over the printed circuit board including the LEDs.

Unfortunately, these previous systems suffer from a variety of problems and shortcomings. For example, even though a thin coating is applied, the protective coating can be pierced or eroded by the high levels of moisture (or other contaminants) typically encountered in many environments thereby exposing the LEDs to these contaminants. Additionally, areas of the protective coating sometimes become removed or fail due to age or other factors thereby exposing the LEDs to the contaminants.

These previous approaches also provide inadequate protection of the printed circuit board components from vibration, shock, and/or other forces. More specifically, previous systems are often susceptible to the components breaking off the printed circuit board when the circuit board experiences even moderate shocks or jolts. For example, jolts and other forces are often encountered by vehicles and absorbed by their lighting systems. In fact, these forces sometimes break the LEDs or other components free from the board or otherwise damage the LEDs in place thereby disabling the operation of the lighting device or otherwise causing these devices to malfunction. Disabled or malfunctioning lighting devices lead to safety concerns for the driver and occupants of the vehicle. Additionally, when the device became disabled, the driver is required to replace the device leading to further safety concerns and inconvenience.

The components of previous lighting devices are also not easily interchangeable amongst a number of different types of assemblies. More specifically, the circuit boards of previous systems are typically designed to specifically fit the shape or configuration of particular housings. Consequently, the circuit boards are not interchangeable amongst different lighting devices and this leads to increased manufacturing costs for these systems.

### SUMMARY

Reliable lighting devices that are substantially protected from the effects of shocks, vibrations, dirt, moisture, water, and/or other hazards or contaminants are provided. Methods of manufacturing lighting devices are also provided. In some examples, these manufacturing approaches include utilizing injection molding techniques to form a lighting subassembly. Furthermore, lighting devices with modular components are provided according to the present approaches and these modular components can be employed in a wide variety of different types of devices having different shapes and configurations. In so doing, manufacturing efficiency and ease of assembly of the lighting device are increased. Manufacturing costs associated with producing light devices are reduced. The operating life and user satisfaction for the devices described herein are also increased compared to previous approaches.

In many of these embodiments, a lighting apparatus includes a lighting subassembly, an electrical coupler, a base portion, and a lens portion. The lighting subassembly includes one or more light emitting devices that are embedded in a solid, light-transmitting material. The one or more light emitting devices and the solid, light-transmitting material form a separate and distinct structure from the other elements of the apparatus. The electrical coupler is configured and arranged to supply energy to the at least one light emitting device from an energy source. The base portion is attached to the lighting subassembly and the lens portion is coupled to the base portion and at least partially covers the lighting subassembly. The lighting subassembly may additionally include a frame. In some examples, the frame is integral with the solid, light-transmitting material.

The light emitting devices may be any type of light-emitting device of any suitable size or configuration. In one example, the light emitting devices are light emitting diodes (LEDs). Other examples of light emitting devices are possible.

The lighting apparatus can be used in a variety of different locations. To take one example, the lighting apparatus may be configured and sized to be disposed in or on a vehicle. Additionally, the lighting apparatus may be used to provide a variety of functions. For example, the lighting apparatus may be used as an out door lighting device, a clearance lamp, a stopping lamp, a tail lamp, a back-up lamp, a turning lamp, a utility lamp, a reading lamp, a license plate lamp, or an interior lamp. Other examples of uses for the lighting apparatus are possible.

The lighting subassembly of the lighting apparatus may further include a printed circuit board that is embedded in the solid, light-transmitting material. In one example, the light emitting devices are coupled to the printed circuit board.

In many of these embodiments, the assembled lens portion and base portion provide a seal to prevent intrusion of external environmental elements from entering the lighting apparatus. For example, an air-tight or moisture-tight seal may be provided.

Various materials can be used for the solid, light-transmitting material. In one example, the solid, light-transmitting material comprises a resin. Other examples of materials may also be used.

In others of these embodiments, a lighting apparatus is manufactured. One or more light emitting devices, a base portion, and a lens portion are provided. The light emitting devices are positioned in a mold. The mold is of suitable structure so as to be injected with a formable material that forms a single-piece subassembly that includes and is formed around the light emitting devices. The single-piece subassembly is cured and removed from the mold. The subassembly is attached to the base portion and the lens portion is attached to the base portion such that the lens portion at least partially covers the subassembly.

In other of these examples, a frame is provided and the light emitting device is positioned so as to be secured by the frame. In other examples, an electrical connector is coupled to the light emitting device and the connector is extended through the base portion and from the subassembly.

In still others of these embodiments, a lighting subassembly includes at least one light emitting device, a solid, light transmitting material, and a mating arrangement. The solid, light-transmitting material at least partially surrounds the at least one light emitting device. The mating arrangement communicates with the solid, light transmitting material and is configured to be attachable to a corresponding base assembly. In some examples, the lighting subassembly further includes a frame and the frame is integral with the solid, light-transmitting material.

Thus, reliable lighting devices are provided that ensure the protection of the lighting apparatus or its components from the effects of shock, vibration, dirt, moisture, water, or other hazards. These approaches increase the life of the lighting devices thereby leading to greater user convenience and satisfaction. The lighting devices described herein can be formed at least partially from modular components and these modular components can be used in a wide variety of different lighting devices having various different shapes and configurations. In so doing, manufacturing flexibility and the ease of assembly are increased and manufacturing costs are reduced. Methods of manufacturing subassemblies are also provided that, in some examples, utilize injection molding techniques.

### BRIEF DESCRIPTION OF THE DRAWINGS

FIG. 1 comprises a perspective drawing of a lighting apparatus according to various embodiments the present invention;

FIG. 2 comprises a cross-sectional view of the lighting apparatus of FIG. 1 along line 116 according to various embodiments of the present invention;

FIG. 3 comprises a bottom view of the lighting apparatus of FIGS. 1 and 2 according to various embodiments of the present invention;

FIG. 4 comprises a perspective view of a lighting subassembly without the inclusion of a solid, light transmitting material according to various embodiments of the present invention;

FIG. 5 comprises a cross-sectional view of the lighting subassembly of FIG. 4 along line 413 of FIG. 4 according to various embodiments of the present invention;

FIG. 6 comprises a perspective view of the lighting subassembly of FIGS. 4 and 5 with the solid, light-transmitting material included according to various embodiments of the present invention; and

FIG. 7 comprises a flowchart for manufacturing a lighting subassembly and/or lighting apparatus according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DESCRIPTION

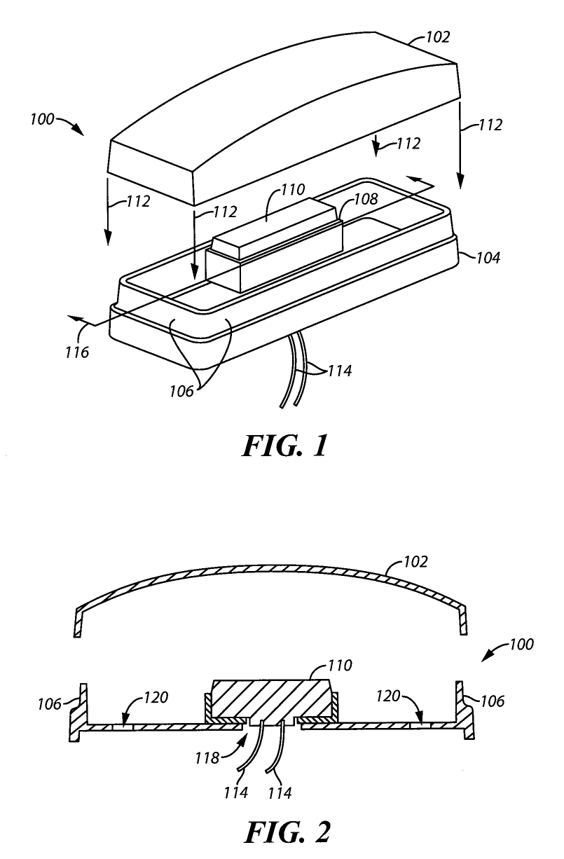

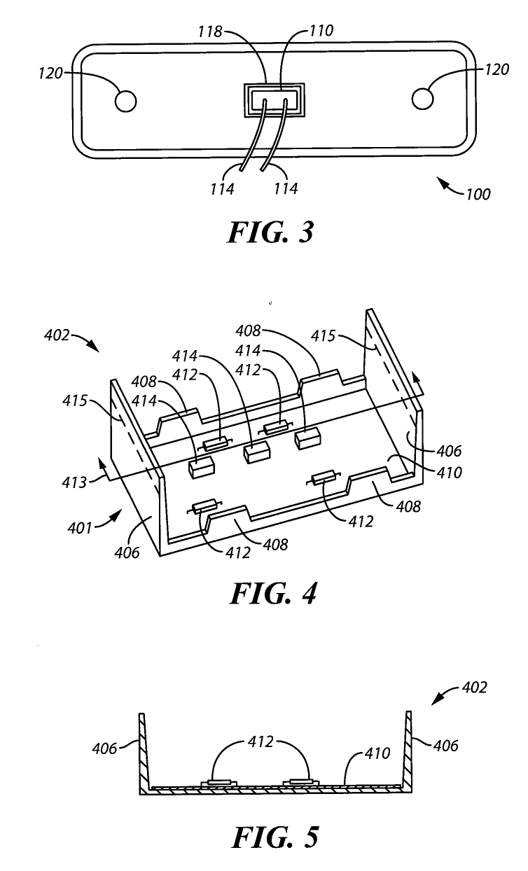

Referring now collectively to FIGS. 1, 2, and 3, a lighting apparatus 100 includes a lens portion 102 and a base portion 104. The base portion 104 includes an integral base holder portion 108. The base section 108 secures a lighting subassembly 110 there within. The subassembly 110 is formed of a solid, light-transmitting material and includes one or more light emitting devices. The subassembly 110 forms a separate and distinct structure from the base portion 104 (including the base holder section 108). Electrical couplers 114 are configured and arranged to supply energy from an energy source (such as a battery or wall electrical supply) to the light emitting devices that reside within the subassembly 110. Although the shape and dimensions of the subassembly 110 formed of the solid, light transmitting material may vary, in one example the subassembly 110 is block shaped and has dimensions of approximately 3.2 cm in length, 0.8 cm in height, and 2 cm in thickness. In any case, the thickness of the solid, light transmitting material is substantially greater than the coatings applied in prior approaches.

The base portion 104 is, in one example, a molded plastic component that includes the base-holder portion 108. The base holder portion 108 may be integrally formed with the base portion 108 and is configured with dimensions such that it holds and secures the subassembly 110. The subassembly 110 fits into the base holder portion 108 and may be secured used adhesive, or some other fastening arrangement. Alternatively, the subassembly may be secured within the base-holder portion 108 at least partially by some other fastening arrangement (e.g., screws or the like) or the base holder portion 108 may be eliminated altogether and the subassembly 110 directly secured to the base portion 104.

In one example, the lens portion 102 is formed of a light-transmitting material (e.g., plastic or glass) that may be colored according to the intended use of the lighting apparatus 100. For example, if used as a stopping lamp, the lens portion may be colored red. In another example, if used as a turning lamp, the lens portion 102 may be colored orange.

The lens portion 102 is coupled to the base portion 104 in the direction shown by the arrows 112 along edge portions 106 and at least partially covers the lighting subassembly 110. Electrical leads 114 extend through an opening 118 and into the lighting subassembly 110. Openings 120 in the base portion 104 may be used to insert a screw or similar fastener arrangements to secure the assembled lighting apparatus 100 to a variety of different locations such as within or on the outside of a vehicle.

In some examples, the lighting subassembly 110 may further include a frame (not shown in FIG. 1). The frame holds the components (e.g., light emitting elements, printed circuit board) of the subassembly 110 to secure these elements when the subassembly 110 is being formed (e.g., molded). In some approaches, the frame is integral with the solid, light-transmitting material used to form the subassembly 110. The frame may be composed of the same material (e.g., a resin) as the other material that surrounds the light-emitting elements or other materials. In others of these approaches, the frame may be omitted.

The electrical leads 114 supply power to the elements of the subassembly 110. However, in other examples, the electrical leads 114 may be omitted and the lighting apparatus is a self-contained unit and includes a battery or similar power device. In other example, a transformer-like arrangement may be used to communicate electrical energy to the components of the assembly 110. The electrical leads 114 may include seals or other structures that prevent the intrusion of moisture or other elements from reaching the light emitting elements in the subassembly.

The light emitting devices may be any type of light-producing component. In one example, the light emitting devices are one or more one light emitting diodes (LEDs). The light emitting devices may also be of any suitable form, dimensions, color, or have any suitable operational characteristic (e.g., power consumption). Other examples of light emitting devices are possible.

The lighting apparatus 100 can be used in a variety of different locations. To take one example, the lighting apparatus 100 is configured and sized to be disposed in a vehicle. The lighting apparatus 100 may also be used to provide a variety of different functions. For example, the lighting apparatus may be used as an out door lighting device, a clearance lamp, a stopping lamp, a tail lamp, a back-up lamp, a turning lamp, a utility lamp, a reading lamp, a license plate lamp, or an interior lamp. Other functions may be provided by the lighting apparatus 100.

The lighting subassembly 110 may further include a printed circuit board that is embedded in the solid, light-transmitting material. In this example, light emitting devices are coupled to the printed circuit board. The printed circuit board may provide other components (e.g., resistors, diodes, capacitors, and controllers) that operate or control the light emitting devices.

In many of these embodiments, the assembled lens portion and base portion provide a seal to prevent intrusion of external environmental elements from entering the lighting apparatus. For example, the lens portion may be tightly secured to the base portion to prohibit the introduction of elements (e.g., provide an air-tight or moisture proof seal or the like). The solid, light transmitting material of the subassembly 110 also prevents the intrusion of these elements from reaching the light emitting devices of the assembly 110 since the solid, light transmitting material surrounds and conformably secures and protects these elements. The solid, light transmitting material of the subassembly 110 also acts as a cushion to prevent shocks or jolts from dislodging or otherwise damaging the light emitting elements or other components of the circuit board.

Various materials can be used for the solid, light-transmitting material. In one example, the solid, light-transmitting material comprises a resin. For example, a clear acrylic or clear polycarbonate resin may be used. Alternatively, the resin may be colored. For example, a red acrylic or red polycarbonate resin may be used. Other examples of materials are possible.

In many of these approaches, the solid, light transmitting materials fits conformably and snuggly around the subassembly components (e.g., the light emitting devices and printed circuit board). The material may be initially in a liquid or semi-liquid form and then poured or applied around these components and thereafter allowed to harden or cure. Consequently, and as mentioned above, moisture and other components cannot access these elements. On the other hand, the light emitting elements and other components of the subassembly are free to operate and light produced by these components is transmitted through the solid, light transmitting material.

Referring now to FIGS. 4-6, one example of a lighting subassembly 402 is described. As shown specifically in FIGS. 4-5, the subassembly 402 is shown without the inclusion of the solid, light transmitting material and before a frame is cut or otherwise adjusted. As shown in FIGS. 4-5, a frame 401 includes side portions 406 and tabs 408. A printed circuit board 410 is placed onto the frame 401 and is held in place by the end portions 406 and the tabs 408. The printed circuit board 410 includes light emitting elements 414 and electrical components 412. The electrical components 412 may be resistors, diodes, capacitors, controllers, or any other electrical component that may be used to control the operation of the light emitting elements 414.

The frame 401 functions to hold printed circuit board 410 and its associated components in place in a mold or similar arrangement when a material is applied to surround these components. The material may originally be liquid and the frame 401 may be placed in the mold. Afterward, the material solidifies to form a solid, light transmitting material 417.

Although the subassembly 402 in these examples includes a frame 401, it will be appreciated that in other examples a frame 401 is not used. For example, a printed circuit board including light emitting elements 414 may be encompassed or surrounded by the solid, light transmitting material without the use of a frame 401. In one example of this approach, the printed circuit board 410 is placed in a mold and injection molding techniques are used to inject a light transmitting material (e.g., initially in a liquid or semi-liquid form) in to the mold. In still other examples, other molding or non-molding techniques (e.g., manually constructing the subassembly from separate components) are used to from the subassembly 402.

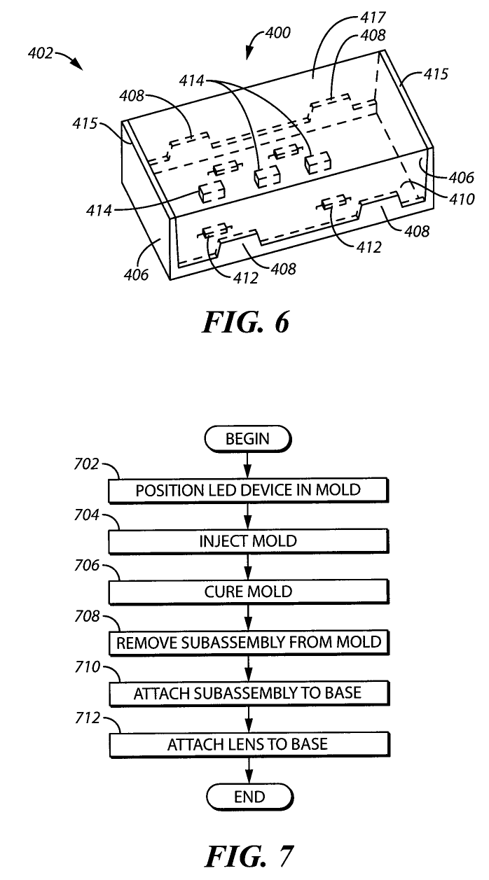

As shown if FIG. 6, the original frame has been cut at edges 415 to reduce its size and allow the finished subassembly 402 to have flush surfaces with no protrusions. Also, a solid, light transmitting material 417 now surrounds and embeds the printed circuit board 410 and includes the light emitting elements 414 on the printed circuit board 410. In one example, the solid, light emitting material 417 is a resin. Other examples of materials may also be used. The solid, light transmitting material 417 may also be selected to transmit various forms of light (e.g., at different wavelengths). For example, the material may be selected to transmit visible, infrared, or ultraviolet light. Other examples of light having other characteristics may also be transmitted according to the nature of the material that is selected.

As also mentioned herein, injection molding techniques may be used to inject a liquid form of the material 417 into a mold and around the components. After pouring or injecting the material, the material may be allowed to solidify, for example, using a curing process. Consequently, the material 417 becomes solid and possesses properties facilitating the transmission of light.

Also as shown in FIG. 6, the subassembly is block shaped. However, it will be understood that the subassembly 402 can be formed of many different types of shapes and configurations. For example, the subassembly 402 may be spherical or conical in shape. Other examples of shapes and configurations are possible.

Although the shape, configuration, and dimensions of the subassembly 402 formed of the solid, light transmitting material may vary, in one example the subassembly 402 is block shaped and has dimensions of approximately 3.2 cm in length, 0.8 cm in height, and 2 cm in thickness. In any case, the thickness of the solid, light transmitting material is substantially greater than the very thin coatings applied in prior approaches.

The subassembly 402 can then be used in a lighting assembly. Also, multiple subassemblies can be used in the same assembly. Additionally, the subassembly 402 is of suitable shape and dimensions so it can fit within a variety of different base portions in a variety of different devices that are used to provide a variety of different functions. Consequently, the subassembly 402 is a modular component that is interchangeable amongst a variety of assemblies having different shapes and dimensions and is not limited to a single application, assembly, housing, environment, or device type.

Referring now to FIG. 7, one example of an approach for manufacturing a lighting apparatus is described. At step 702, one or more light emitting devices are positioned in a mold. For example, the mold may be a block-shaped mold that is used in injection molding processes. The one or more light emitting devices may be positioned on a printed circuit board. The printed circuit board may also have other components such as resistors, capacitors, diodes, controllers, or the like.

At step 704, the mold is injected with a formable material to form a single-piece subassembly that includes and is formed around the one or more light emitting devices. For example, the material may be a resin that transmits light. Other examples of materials are possible. As mentioned the material may be injected in liquid or semi-liquid form. Also as mentioned, the material may be selected to transmit certain types of light (e.g., visible light, infrared light, or ultraviolet light). In so doing, the injected material provides a snug, tight, and conforming fit around the components while at the same time allowing these components to operate. In one example, the injected material is a hot material that has a temperature of between approximately 350-400 degrees Fahrenheit. Other examples of temperature may also be used.

At step 706, the mold is cured. For example, the mold (including the subassembly) may be allowed to cool for, in one example, between approximately 10-15 seconds. This allows the mold to cool to between room temperature and 100 degrees Fahrenheit in order to cure (or set-up) the subassembly. After this step is performed, the subassembly is in a solid form. Although the shape and dimensions of the subassembly formed of the solid, light transmitting material may vary, in one example the subassembly is block shaped and has dimensions of approximately 3.2 cm in length, 0.8 cm in height, and 2 cm in thickness. In any case, the thickness of the solid, light transmitting material is substantially greater than the coatings applied in prior approaches. At step 708, the subassembly is removed from the mold.

At step 710, after removal from the mold the subassembly is attached to the base portion. At step 712, a lens portion is attached to the base portion such that the lens portion at least partially covers the subassembly.

Although the above examples are described with respect to utilizing injection molding techniques to form the subassembly, it will be appreciated that other types of manufacturing techniques may also be used. For instance, other conventional molding techniques may also be used to form the subassembly.

Thus, lighting devices are provided that provide reliable lighting and that are protected from shock, vibration, dirt, moisture, water, or other hazards. These approaches increase the life of the lighting elements used to provide illumination and thereby lead to greater user convenience and satisfaction with these system. The devices provided herein can be constructed from modular components and these modular components can be used in a wide variety of devices having different shapes, dimensions, and configurations. In so doing, manufacturing flexibility and the ease of assembly are increased while manufacturing costs are reduced. Methods of manufacturing subassemblies are also provided utilizing injection molding techniques.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A lighting apparatus, comprising:
a lighting subassembly including at least one light emitting device that is embedded in a solid, light-transmitting material, the at least one light emitting device and the solid, light-transmitting material forming a separate and distinct structure;
an electrical coupler configured and arranged to supply energy to the at least one light emitting device from an energy source;
a base portion attached to the lighting subassembly;
a lens portion coupled to the base portion and at least partially covering the lighting subassembly.

2. The lighting apparatus of claim 1 wherein the lighting subassembly further comprises a frame, the frame being integral with the solid, light-transmitting material.

3. The lighting apparatus of claim 1 wherein the at least one light emitting device comprises at least one light emitting diode (LED).

4. The lighting apparatus of claim 1 wherein the lighting apparatus is configured and sized to be disposed in a vehicle.

5. The lighting apparatus of claim 1 wherein the lighting apparatus is configured to be a lamp selected from a group consisting of: an out door lighting device; a clearance lamp; a stopping lamp; a tail lamp; a back-up lamp; a turning lamp; a utility lamp; a reading lamp; a license plate lamp; and an interior lamp.

6. The lighting apparatus of claim 1 wherein the lighting subassembly further includes a printed circuit board that is embedded in the solid, light-transmitting material and wherein the at least one light emitting device is coupled to the printed circuit board.

7. The lighting apparatus of claim 1 wherein the assembled lens portion and base portion provide a seal to prevent intrusion of external environmental elements from entering the lighting apparatus.

8. The lighting apparatus of claim 1 wherein the solid, light-transmitting material comprises a resin.

9. A method of manufacturing a lighting apparatus comprising:
providing at least one light emitting device, a base portion, and a lens portion;
positioning the at least one light emitting device in a mold;
injecting the mold with a formable material to form a single-piece subassembly that includes and is formed around the at least one light emitting device;
curing the single-piece subassembly;
removing the single-piece subassembly from the mold;
attaching the subassembly to the base portion; and
attaching the lens portion to the base portion such that the lens portion at least partially covers the subassembly.

10. The method of claim 9 further comprising providing a frame and positioning the light emitting device so as to be secured by the frame.

11. The method of claim 9 further comprising coupling an electrical connector to the light emitting device and extending the connector through the base portion and from the subassembly.

12. The method of claim 9 wherein providing the at least one light emitting device comprises providing at least one light emitting device on a printed circuit board.

13. The method of claim 9 further comprising installing the completed lighting apparatus within or on a vehicle.

14. The method of claim 13 wherein the lighting apparatus is configured to operate as a lamp selected from a group consisting of: a clearance lamp; a stopping lamp; a tail lamp; a back-up lamp; a turning lamp; a utility lamp; a reading lamp; a license plate lamp; and an interior lamp.

15. A vehicular lighting apparatus comprising:
a base portion;
a lighting subassembly coupled to the base portion, the lighting subassembly being formed of a solid, light-transmitting material surrounding an embedded printed circuit board, the embedded printed circuit board including at least one light emitting device;
an electrical coupler coupled to the printed circuit board and configured and arranged to supply energy to the printed circuit board from a vehicular power source;
a lens portion, the lens portion attached to the base portion and at least partially covering the lighting subassembly; and
wherein the vehicular lighting apparatus is configured and sized to be disposed within or on a vehicle.

16. The vehicular lighting apparatus of claim 15 wherein the lighting subassembly further comprises a frame, the frame being integral with the solid, light-transmitting material.

17. The vehicular lighting apparatus of claim 15 wherein the vehicular lighting apparatus is configured and arranged to be used as a vehicular lamp selected from a group consisting of: a clearance lamp; a stopping lamp; a tail lamp; a back-up lamp; a turning lamp; a utility lamp; a reading lamp; a license plate lamp; and an interior lamp.

18. The vehicular lighting apparatus of claim 15 wherein the assembled lens portion and base portion provide a seal to at least partially prevent the intrusion of external environmental elements into the lighting apparatus.

19. The vehicular lighting apparatus of claim 15 wherein the solid, light-transmitting material comprises a resin.

20. A lighting subassembly, comprising:
at least one light emitting device;
a solid, light-transmitting material that at least partially surrounds the at least one light emitting device; and
a mating arrangement, the mating arrangement communicating with the solid, light transmitting material, the mating arrangement configured to be attachable to a corresponding base assembly.

21. The lighting subassembly of claim 20 further comprising a frame, the frame being integral with the solid, light-transmitting material.

22. The lighting subassembly of claim 20 wherein the at least one light emitting device comprises at least one light emitting diode (LED).

23. The lighting subassembly of claim 20 wherein the lighting subassembly is configured to be disposed within a lamp selected from a group consisting of: an out door lighting device, a clearance lamp; a stopping lamp; a tail lamp; a back-up lamp; a turning lamp; a utility lamp; a reading lamp; a license plate lamp; and an interior lamp.

24. The lighting subassembly of claim 20 further comprising a printed circuit board that is embedded in the solid, light-transmitting material and wherein the at least one light emitting device is coupled to the printed circuit board.

25. The lighting subassembly of claim 20 wherein the solid, light-transmitting material comprises a resin.
